(19) United States
(12) Patent Application Publication
(10) Pub. No.: US 2014/0091904 A1
(43) Pub. Date: Apr. 3, 2014

(54) Secure Code Entry in Public Places

(71) Applicant: ScienceHA, Inc., (US)

(72) Inventors: Sina Salahshor, Tyreso (SE); Nima Bahramifarid, Toronto, CA (US)

(73) Assignee: ScienceHA, Inc., Toronto (CA)

(21) Appl. No.: 13/794,518

(22) Filed: Mar. 11, 2013

Related U.S. Application Data
(60) Provisional application No. 61/611,520, filed on Mar. 15, 2012.

(51) Int. Cl. G07C 9/00

(52) U.S. Cl. CPC G07C 9/00142
USPC 340/5.54

(57) ABSTRACT

The disclosure provides an apparatus and method for secure code entry in public places. The code entry apparatus includes a display for displaying a code character, the display having a structure that assures that only the user of the apparatus can view the code character; a character selector for selecting the code character; and an input device for confirming selection of the code character.

### TECHNICAL FIELD

This disclosure relates to the field of code entry, more specifically, to secure code entry in public places.

### BACKGROUND

Code entry is used in many varied situations and locations. For example, personal identification number (PIN) code entry is a common example of a code that needs to be entered at an automatic teller machine (ATM) in order to withdraw money from a bank account. In this case, the code or secure code is entered through a numeric keypad to identify the individual and authorize the transaction, in combination with the bank card. Secure codes are also used in many other situations such as, store cashier machines, building entry door locks, and office safe boxes.

Generally, the secure code entry is performed by a person in a public space with or without other people around. Existing PIN code entry pads generally consist of a grid of numbered buttons, e.g. the numbers 0 to 9, along with confirmation and correction buttons.

### SUMMARY

In one broad aspect, a code entry apparatus includes a display for displaying a code character, the display having a viewing angle adjustable by a user; a character selector for selecting the code character; and an input device for confirming selection of the code character. The code entry apparatus may include an adjustable tunnel surrounding the display for restricting the display of the code character only to the user, or for restricting the viewing angle of the display. The display may have a polarizing cap for restricting the display of the code character only to the user. The code entry apparatus may further include a light control film covering the display for restricting the display of the code character only to the user.

In another broad aspect, provides a method for securely entering a code includes the steps of providing a display for restricting the display of a code character only to the user; viewing the displayed code character on the display; using a character selector to select the displayed code character; and selecting the displayed code character with an input device. The method for securely entering a code may also include the step of providing a display with an adjustable viewing angle, or, surrounding the display with an adjustable tunnel for restricting the viewing angle of the display, or, providing a light control film covering the display for restricting the viewing angle of the display, or, a combination of the above.

In another broad aspect, a code entry apparatus includes a display for displaying a code character, the display having a structure that assures that only the user of the apparatus can view the code character; a character selector for selecting the code character; and an input device for confirming selection of the code character.

The described apparatus and method improve the security of code entry by allowing for secure code entry in public places by restricting viewing of the code character only to the user who inputs the code character. The described apparatus and method thus substantially prevent others from viewing the code as it is being entered or to record the secure code during entry, either overtly or covertly, which would compromise the security of the secure code.

### DESCRIPTION OF THE DRAWINGS

In the accompanying drawings:

FIG. 1 is a perspective view of an exemplary implementation of a code entry apparatus;

FIG. 2 is a cross-sectional view of an exemplary implementation of a tunnel and a display of an exemplary implementation of a code entry apparatus as depicted in FIG. 1;

FIGS. 3 and 3A are exploded views of an exemplary implementation of a code entry apparatus;

FIGS. 4 and 4A are top perspective views of an exemplary implementation of a code entry apparatus as depicted in FIGS. 3 and 3A, with the code shielded;

FIGS. 5 and 5A are top perspective views of an exemplary implementation of a code entry apparatus as depicted in FIGS. 3 and 3A, with the code in view only to the user who entered the code; and

FIG. 6 is a drawing of another implementation of the layout of the electronics on the mounting plate and an electrical bill of materials for an implementation of a code entry apparatus.

### DETAILED DESCRIPTION

For clarity, the term “code character” can encompass an arbitrary set of characters depending on the implementation. Generally, in most implementations, the code character consists of a set of alphanumeric characters. The act of incrementing or decrementing a code character means going to the next code character in the sequence.

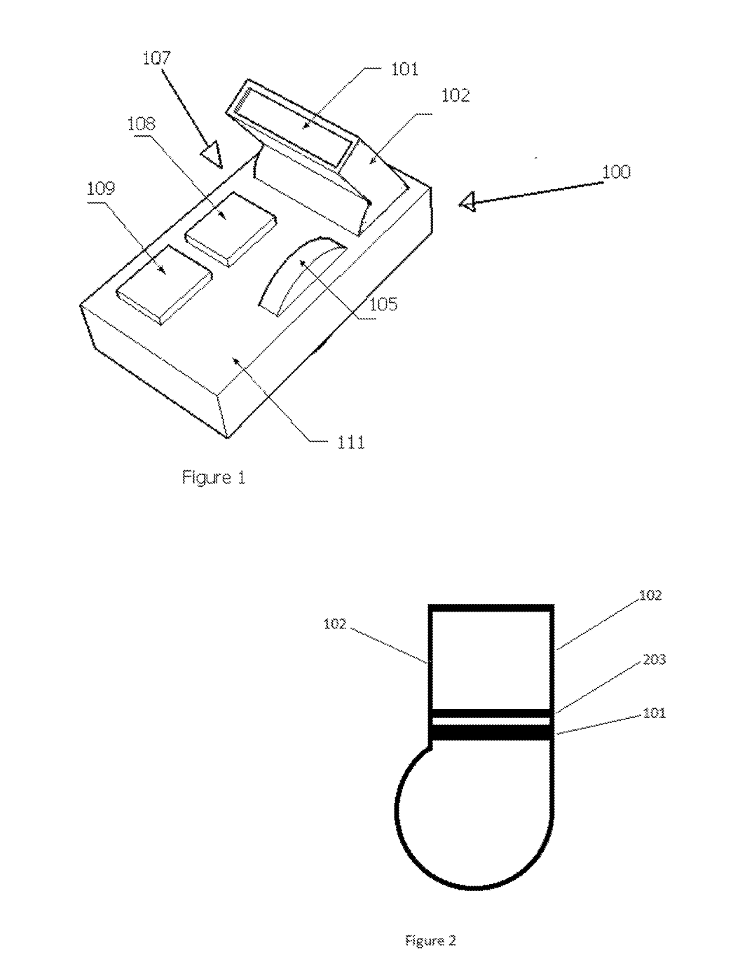

Referring now to FIG. 1, one implementation of a code entry apparatus 100 is shown. The code entry apparatus 100 includes a display 101 that is surrounded by a tunnel 102. The display 101 is preferably located within the tunnel 102 and is structured and arranged for displaying a code character to only to the user of the apparatus 100. The hollow area of the tunnel 102 is wide enough to view the code characters displayed on the display 101. The display 101 may be located anywhere within the tunnel 102, but is preferably located near the base of the tunnel 102. The display 101 has a viewing angle that is adjustable by the user, that is, so the code character is visible only to the user when the direct field of vision or viewing angle of the user is within the viewing angle of the display 101. Additionally, the tunnel 102 can be manipulated to change the viewing angle of the display 101 by, in one implementation, allowing the user manually to tilt the display 101, and thereby to change the viewing angle relative to the user. It is understood that the viewing angle of the display 101 is also referred to as the viewing direction and may be defined by both an azimuth and inclination angle. It is also understood that the multitude of viewing angles or viewing directions creates a viewing cone.

The viewing angle of the display 101 is established by adjusting the tunnel 102 or a light control film 203 (see FIG. 2) or both, and generally provides further security by making it more difficult for other observers outside the viewing angle of the display 101 to view the code characters displayed in the tunnel 102. The light control film 203 may be applied to the surface of the display 101 as seen by the user, and works to restrict the range of the viewing angle of the display 101. The tunnel 102 or film 203 or both would be used, or not used, with the display 101 depending on the specific application of the implementation. For example, an implementation used in a safe deposit box (which may not been seen by other members of the public) may not require the tunnel to be adjustable, or, due to manufacturing of a cost sensitive implementation, the film may not be applied to the display.

The display 101 may be a liquid crystal display (LCD) or light emitting diode (LED) display or other electronically controllable display. For example, in cost-sensitive implementations, a seven segment LCD or LED display could be used.

In use, the character selector 105 provides for selecting or scrolling the displayed code character. In some implementations, the character selector 105 is a scroll wheel, similar to those found on a computer mouse. The code character displayed on the display 101 is either incremented or decremented according to how the character selector 105 is used. For example, the user may select or scroll “up” or “down” towards the next code character in the sequence. Other implementations of the character selector 105 could be implemented among other obvious variations, e.g., using a touch screen type surface, trackball, or buttons.

Once the desired code character is displayed on the display 101 only to the user, by the user adjusting the tunnel 102, the display 101 located in the tunnel may or may not have a light control film 203 (see FIG. 2) applied to it, following the use of the character selector 105, then the user can confirm their selection by activating an input device indicated generally by reference number 107. The input device 107 may be a button, such as an “enter” key 108. The code entry apparatus 100 may also include a reversing device, such as a “revert” key 109 for reversing confirmation of a selected code character. The “revert” key 109 is used to clear the confirmation of a code character that was previously selected by the user. For example, in an implementation, when the user incorrectly confirms a code character, then the confirmation could be cleared by using the “revert” key 109. The “revert” key 109 may be a button. Either the “enter” key 108 or the “revert” key 109 or both could be implemented using a touch screen type surface, trackball, clickable scroll wheel, or other obvious variation.

In the implementation illustrated in FIG. 1 and FIG. 2, a processor for controlling the display 101 and output device in response to input from the character selector 105, “enter” key 108 or the “revert” key 109 is preferably located within the casing 111. The casing 111 is optional depending on the implementation of the code entry apparatus 100. For example, if the implementation is part of a system such as an ATM then the casing 111 is not required, since all other essential elements are located within, or are part of, the ATM.

The processor can be a low-cost microprocessor with associated software code but is understood to include alternatives such as an application specific integrated circuit (ASIC) or an electronic circuit, or combination of the above, among other obvious alternatives. The processor controls the display 101 and updates the displayed code character in response to input. If the character selector 105 is used then the processor will cause the display 101 to display an incremented or decremented code character as appropriate. If the input device 107 is used then the processor will cause the display 101 to display a response to indicate to the user that the code character was confirmed. For example, in an implementation, upon using the “enter” key 108 the displayed code character, such as a number, is replaced with a “*”. Analogously, if the “revert” key 109 is used then the processor will cause the display to indicate to the user that the previously confirmed code character is no longer confirmed. For example, in another implementation, upon using the “revert” key 109, the confirmation character “*” is replaced with a code character, such as a number.

In the use of the code entry apparatus shown and described in FIG. 1 and FIG. 2, a user of the code entry apparatus begins using the apparatus by adjusting a viewing angle of a display 101, so that only the user can view the code character on the display due to the limited viewing angle of the display either because of the tunnel or light control film or combination used to restrict or narrow the viewing angle of the display. Only the user should be able to view a displayed code character on the display 101. Next, the user scrolls or uses the character selector 105 to change the displayed code character. Then the user selects the displayed code character with an “enter” key 108, which is part of the input device 107. In an implementation, the user also can incorporate the step of reversing confirmation of a selected code character. The use also includes the step of generating an output signal with an output device in response to input from the character selector 105, the “enter” key 108, and/or the “revert” key 109.

As noted above, in use, the processor can also control an output device to generate an output signal in response to inputs from the character selector 105, the “enter” key and/or the “revert” key 109. Depending on the implementation, the processor can cause the output device to generate various output signals to indicate, for example, the code character currently displayed to another component in a system such as an ATM, or to emulate the output signals of another type of input device, or any other required electrical signals that a skilled person would understand as being required to interface an implementation of the code entry apparatus within an encompassing or existing system.

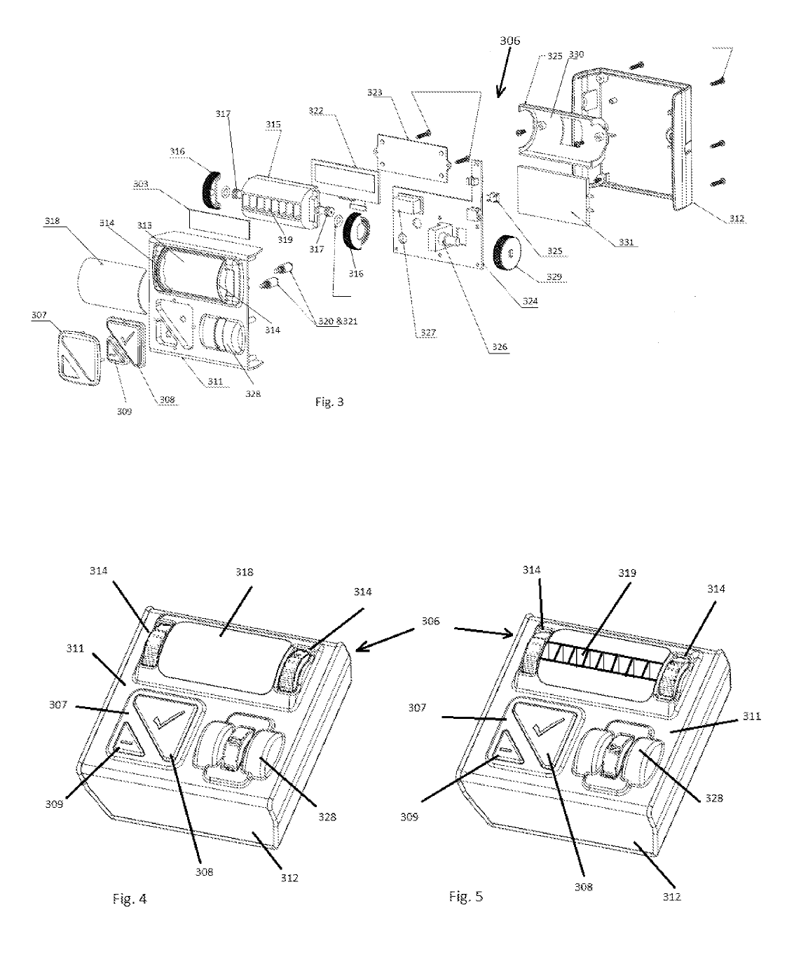

In the exploded view of FIGS. 3 and 3A, the code entry apparatus 300 includes a top housing 311 and a bottom housing 312 which, between them, house all elements, to be described hereinafter constituting this implementation. The top housing includes a button bezel 307 that encompasses an “enter” key 308 or an “accept” button, which is connected to button switch 320, and a “revert” key 309 or “cancel” button, which is connected to button switch 321.

While not shown in FIGS. 3 and 3A, but which will be described hereinafter, the code entry apparatus includes a processor connected to an “enter” key 308 and to a “revert” key 309. The processor may also be connected to a wireless transmitter (not shown), the wireless transmitter may be WI-FI or BLUETOOTH compatible, or other variation known to a skilled person.

The top housing 311 includes an opening slot 313 having arcuate outer edges 314 through which tunnel display housing 315, which is provided with display rotator wheels 316 at outer edges thereof, projects when secured to the top housing 311 by means of longitudinally-extending cylindrical treaded connectors 317. The tunnel display housing 315 may also include an optional polarized cap 303 to act as a light control film, if needed. In an example implementation, the slot opening 313 is provided with a manually-rotatable, arcuate shield 318 for selectively showing or hiding entry codes that have been manually-entered on the entry code display wells 319 of the tunnel display housing 315, which are manually rotatable by means of selector wheel 329. In another example implementation, the shield 318 may be fixed and not rotatable. In this alternative implementation, the display tunnel housing 315 is rotatable. A skilled technician would understand that alternate ways to selectively show or hide entry codes could be used without departing from the scope of this disclosure. For example, the display tunnel housing 315 may also have baffles or individual tunnels separating each character to further limit the angle of vision. The entry code is displayed on an LED screen 322, which is located behind the entry code display wells 319. The display tunnel housing 315 and the LED screen 322 are secured by LED backing plate 323, mounting plate 324 and display rotator backing shield 330 to provide a housing for those elements.

The mounting plate 324, as shown in detail in FIGS. 3 and 3A, has mounted thereon, a display wheel rotator diode and sensor 325, a selector potentiometer 326, a power converter 327 and unit master power button (not shown). The power converter 327 is covered by a protective shield 328 secured to the top housing. A battery pack 331 is secured to the interior of the bottom housing 312.

Another example implementation of a mounting plate 324 with associated electrical component layout is provided in FIG. 6. FIG. 6 also lists the electrical and PCB bill of materials associated with this implementation.

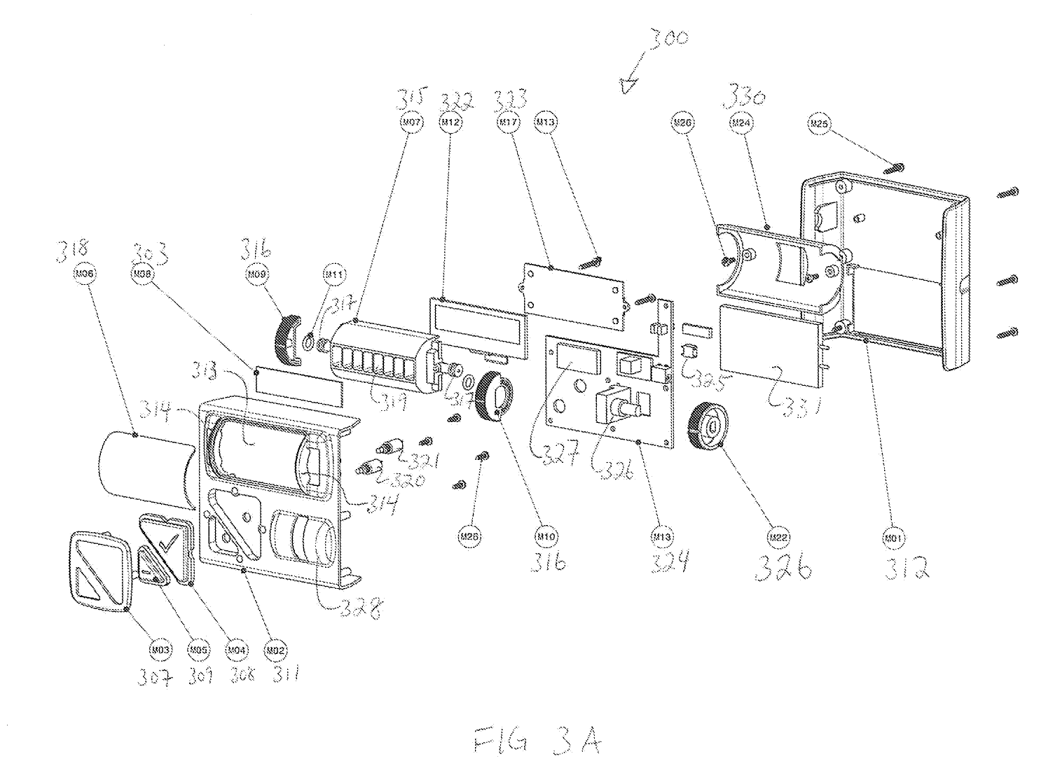

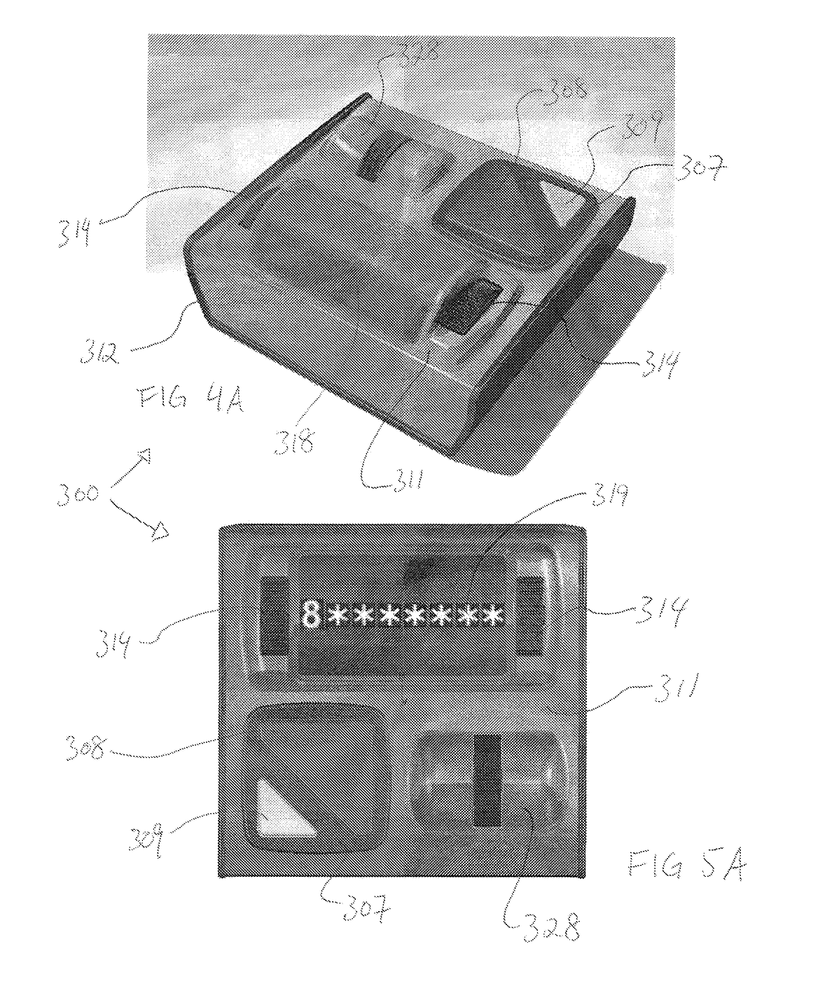

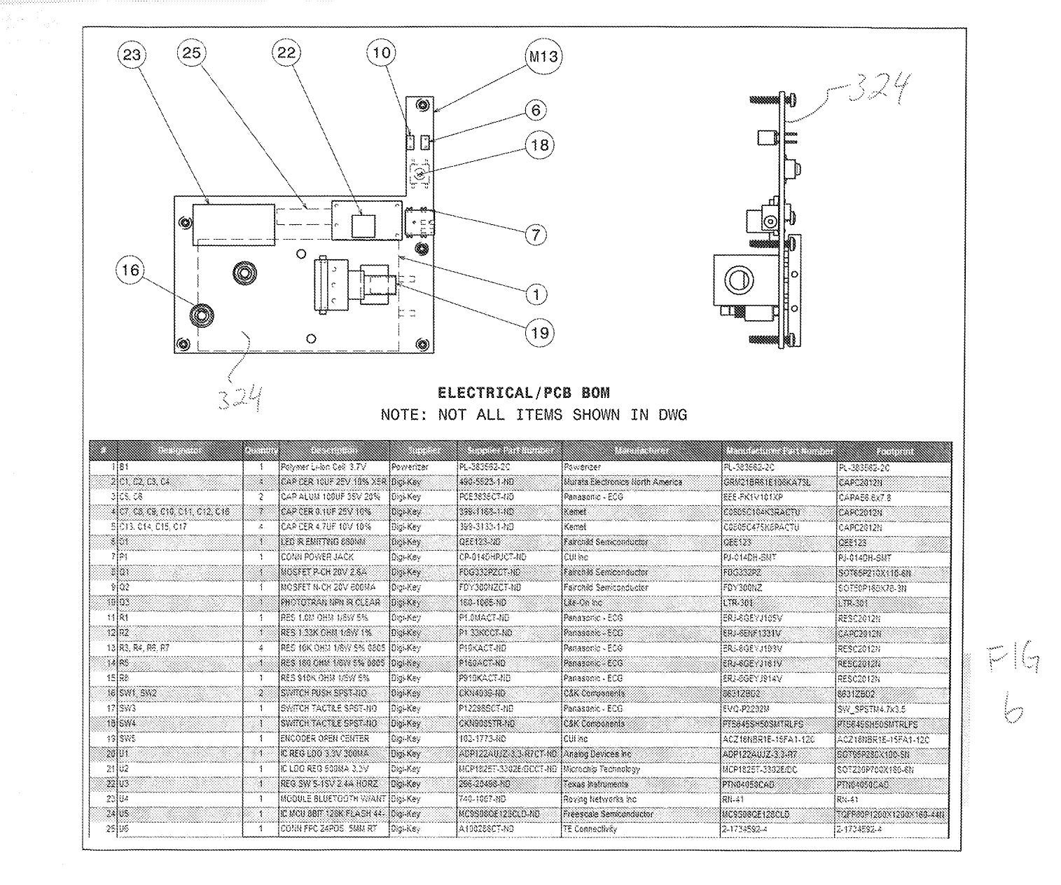

When the top housing 311 and the bottom housing 312 are secured together, they provide the entry code display apparatus 300 as shown in FIGS. 4 and 4A and FIGS. 5 and 5A.

In the use of the code entry apparatus shown and described in FIGS. 3 and 3A and FIGS. 5 and 5A, a user of the code entry apparatus can start using the apparatus by manually-rotating the housing 315 and screen 322 so that only the user can view entered code characters on the display wells 319. A user may also rotate the tunnel display housing 315 to adjust the viewing angle of the display 322 by using display rotator wheels 316. Next, the user scrolls the selector wheel 329 to change the displayed code character. Then the user selects the displayed code character with an “input” key 308. In an alternative implementation, the use also could incorporate the step of reversing confirmation of a selected code character by using the “revert” key 309 for reversing confirmation of a selected code character. The use may also include step of generating an output signal with an output device in response to input from the characters on the selector wheel 329, the “input” key 308, and/or the “revert” key 309.

As noted above, in use, the processor can also control an output device to generate an output signal in response to inputs from the characters on the selector wheel 329, the “enter” key 308 and/or the “revert” key 309. Depending on the implementation, the processor causes the output device to generate various output signals to indicate, for example, the code character currently displayed to another component in a system such as an ATM, or to emulate the output signals of another type of input device, or any other required electrical signals that a skilled person would understand as being required to interface an implementation of the code entry apparatus within an encompassing or existing system.

Although the implementations are described in terms of viewing, scrolling, selecting, and clearing a code character, that there is no limitation as to the number of code characters that could viewed, scrolled, selected or cleared, other than the specific limitations that certain implementations impose, for example, displaying a limited amount of code characters due to the size of a display or the amount of memory available to the processor.

The program used by the processor to increment or decrement, or scroll, the code characters is not limited to simply displaying the next code character in the sequence. For example, the code characters could be incremented or decremented by an arbitrary numbers of code characters in the sequence depending on the specific implementation. Also, it is not a limitation of the system to display the same code character upon initial use by a user. For example, in an implementation, the processor could cause a random code character to be initially displayed to the user, and then the user could use the character selector to scroll to the desired code character.

A mechanical equivalent of the disclosed manipulation of the tunnel could be the substitution of the tunnel by a slidable shroud over the display; the slidable shroud can be longitudinally moved over the display to change the viewing angle over the display.

The disclosure herein has been described with reference to specific exemplary implementations; however, other implementations are within the scope of the following claims.

What is claimed is:

1. A code entry apparatus comprising:
a display for displaying a code character, the display having a viewing angle adjustable by a user;
a character selector for selecting the code character; and
an input device for confirming selection of the code character.

2. The code entry apparatus of claim 1, further comprising an adjustable tunnel surrounding the display for restricting the display of the code character only to the user, or for restricting the viewing angle of the display.

3. The code entry apparatus of claim 2, wherein the display has a polarizing cap for restricting the display of the code character only to the user.

4. The code entry apparatus of claim 3, further comprising a light control film covering the display for restricting the display of the code character only to the user.

5. The code entry apparatus of claim 1, further comprising: a reversing device for reversing confirmation of a selected code character.

6. The code entry apparatus of claim 1, wherein the character selector is a scroll wheel.

7. The code entry apparatus of claim 6, where the input device is a button.

8. The code entry apparatus of claim 1, further comprising: an output device for generating an output signal.

9. The code entry apparatus of claim 8, further comprising: a processor for controlling the display and output device in response to input from the character selector, the input device and the reversing device.

10. A method for securely entering a code comprising:
providing a display for restricting the display of a code character only to the user;
viewing the displayed code character on the display;
using a character selector to select the displayed code character; and
selecting the displayed code character with an input device.

11. The method according to claim 10, wherein providing a display for restricting the display of a code character only to the user further comprises providing a display with an adjustable viewing angle.

12. The method according to claim 10, wherein providing a display for restricting the display of a code character only to the user further comprises surrounding the display with an adjustable tunnel for restricting the viewing angle of the display.

13. The method according to claim 10, wherein providing a display for restricting the display of a code character only to the user further comprises providing a light control film covering the display for restricting the viewing angle of the display.

14. The method according to claim 10, wherein providing a display for restricting the display of a code character only to the user further comprises:
providing a display with an adjustable viewing angle;
surrounding the display with an adjustable tunnel for restricting the viewing angle of the display; and
providing a light control film covering the display for restricting the viewing angle of the display.

15. The method according to claim 14, further comprising reversing confirmation of a selected code character with a reversing device.

16. The method according to claim 15, further comprising generating an output signal with an output device.

17. A wireless method for securely entering a code comprising:
providing a portable device having a housing, a display carried by the housing, an input device carried by the housing for receiving user information, a wireless transceiver carried by the housing, and a processor carried by the housing and coupled to the display, input device, and wireless transceiver; and
wirelessly sending the user information derived from a selected code character for verifying the code entry to complete the entry.

18. A code entry apparatus comprising:
a display for displaying a code character, the display having a structure that assures that only the user of the apparatus can view the code character;
a character selector for selecting the code character; and
an input device for confirming selection of the code character.

19. The code entry apparatus of claim 18 wherein the structure that assures that only the user of the apparatus can view the code character comprises a viewing angle adjuster that is adjustable by a user.

20. The code entry apparatus of claim 18 wherein the structure that assures that only the user of the apparatus can view the code character comprises a member for restricting the viewing angle of the display.
